(19) United States
(12) Patent Application Publication
(10) Pub. No.: US 2023/0196866 A1
(43) Pub. Date: Jun. 22, 2023

(54) SYSTEM AND METHOD FOR FEATURE MANAGEMENT

(71) Applicant: DEKA Products Limited Partnership, Manchester, NH (US)

(72) Inventors: Dean KAMEN, Bedford, NH (US); Thomas A. DOYON, Manchester, NH (US); Karla BEAGLE, Bedford, NH (US); Jay C. BURKHOLDER, Lexington, MA (US)

(21) Appl. No.: 18/065,829

(22) Filed: Dec. 14, 2022

Related U.S. Application Data
(60) Provisional application No. 63/265,612, filed on Dec. 17, 2021.

(51) Int. Cl. G07F 17/08; A61G 5/06

(52) U.S. Cl. CPC G07F 17/08; A61G 5/061

(57) ABSTRACT

A system for controlling the features of a device, and in particular, controlling the features based on a variety of triggers, both internal and external, such as, for example, but not limited to, safety, user actions, and economics. With respect to internal triggers, the system can enable the device to shut down its features when certain types of behaviors or environmental parameters are detected. With respect to external triggers, the system can enable the device features to be controlled externally based on pre-established or dynamically-determined parameters. With respect to safety triggers, the system can determine if a device is currently in a specific state, and if so, determine what controls are appropriate in the specific state.

### CROSS-REFERENCE TO RELATED APPLICATIONS

This application claims the benefit of U.S. Provisional Patent Application Ser. No. 63/265,612, filed Dec. 17, 2021, entitled SYSTEM AND METHOD FOR FEATURE MANAGEMENT, (Attorney Docket No. AA710), which is incorporated herein by reference in its entirety.

### BACKGROUND

This disclosure relates generally to feature management in contracted equipment. More specifically, this disclosure pertains to techniques for controlling feature availability by the owner of the equipment. Equipment can come in all sizes and types. Smart devices are electronic, and are usually operably coupled with networks and devices through various protocols such as, but not limited to Bluetooth, Zigbee, NFC, Wi-Fi, LiFi, and 5G. Examples of smart devices include smartphones, cars, smart refrigerators, tablets, and watches. In the world of the Internet of Things (IoT), there are systems for controlling devices, usually in homes, and interfacing with functions in vehicles. Device control can happen wirelessly through, for example, but not limited to, RF, Zigbee, Zwave, WiFi. Logitech's Harmony Hub is a device that pairs with a cellular device to control smart home devices. Device manufacturers can also control their devices remotely, and devices such as Amazon's Alexa can communicate with the manufacturer to control devices through voice commands. The Sierra Wireless AirLink wireless gateway supports remote management, control, configuration, and application services for industrial, enterprise, and automotive applications. The Sierra Wireless AirVantage application collects, shares, and integrates machine data using application programming interface (API) standards.

FIG. 1 (PRIOR ART) illustrates a thermostat controlled by a cell phone using wireless technology and a control server. The application on the cell phone uses, in this example, the HTTPS protocol to communicate commands to a control server. The control server also uses, in this example, the HTTPS protocol to communicate with the thermostat and pass the commands initiated by the cell phone to the thermostat. The thermostat can respond through the control server to provide status and other information to the cell phone. Application Programming interfaces (APIs) enable communication across the web using, for example, but not limited to, the hypertext transfer protocol (HTTPS) or MQTT protocol. The API enables a computer program to communicate with another computer program, for example, a computer program executing in the cell phone and a computer program executing in the thermostat. The API provides a list of commands that are acceptable to the computer program to which the communication is directed. Open APIs can be accessed by anyone and can be used to control devices. Closed APIs can be used as well to control devices, their access being granted by the manufacturer of the device.

In another example, PowerFleet sells products that secure, control, track, and manage industrial trucks, tractor trailers, and other high-value assets. PowerFleet's vehicle access communicator can interface with functions in a rental vehicle, for example, and control the functions of the vehicle for the purpose of monitoring rental cars during checkin. In yet another example, PassTime GPS solutions can disable a vehicle if the payment for the vehicle is past due.

Although device control and the ability to disable a vehicle based on payment status is available, what is needed is a way to enable and disable features of a device, and in particular, to enable and disable features based on a variety of triggers, both internal and external, such as, for example, but not limited to, safety, user actions, and economics. What is further needed is a system by which the device can control when and from whom enable/disable commands are received.

With respect to internal triggers, what is needed is a device that can shut down its features when certain types of behaviors or environmental parameters are detected. What is further needed is an analysis function to evaluate combinations of parameters and detect a trigger based on the analysis. With respect to external triggers, what is needed is a device whose features can be controlled externally based on pre-established or dynamically-determined parameters. With respect to safety triggers, what is needed is a system that determines if a device is currently in a specific state, and if so, a way is needed to determine whether disabling a feature of the device would be unsafe to perform while the device is in the current state. After it is determined that switching off the feature would be safe, what is needed is a way to switch off the feature (or turn the feature on) based on at least one trigger. An economic trigger can include, but is not limited to including, payment or the lack of payment towards rental, leasing, or purchase of the device. What is further needed is a way to indirectly disable/enable features based on a relationship between features.

The above-described background is merely intended to provide a contextual overview of some current issues, and is not intended to be exhaustive.

### BRIEF DESCRIPTION OF THE DRAWINGS

Non-limiting and non-exhaustive aspects of the subject disclosure are described with reference to the following figures, wherein like reference numerals refer to like parts throughout the various views unless otherwise specified.

FIG. 1 (PRIOR ART) is a pictorial representation of device control in using a handheld device and a control server;

FIGS. 1A-1B are handshaking diagrams of the device control protocol of the present teachings;

FIGS. 2A-2D are pictorial representations of device modes of an exemplary device to be controlled by the system of the present teachings;

FIG. 3 is a schematic block diagram of an exemplary configuration of the system of the present teachings;

FIG. 4 is a schematic block diagram of a second exemplary configuration of the system of the present teachings; and

FIG. 5 is a flowchart of the method of the present teachings.

### DETAILED DESCRIPTION

In the following description, numerous specific details are set forth to provide a thorough understanding of various aspects and arrangements. One skilled in the relevant art will recognize, however, that the techniques described herein can be practiced without one or more of the specific details, or with other methods, components, materials, etc. In other instances, well known structures, materials, or operations may not be shown or described in detail to avoid obscuring certain aspects.

Reference throughout this specification to “an aspect,” “an arrangement,” or “a configuration” indicates that a particular feature, structure, or characteristic is described. Thus, appearances of phrases such as “in one aspect,” “in one arrangement,” “in a configuration,” or the like in various places throughout this specification do not necessarily each refer to the same aspect, feature, configuration, or arrangement. Furthermore, the particular features, structures, and/or characteristics described may be combined in any suitable manner.

To the extent used in the present disclosure and claims, the terms “component,” “system,” “platform,” “layer,” “selector,” “interface,” and the like are intended to refer to a computer-related entity or an entity related to an operational apparatus with one or more specific functionalities, wherein the entity may be either hardware, a combination of hardware and software, software, or software in execution. As an example, a component may be, but is not limited to being, a process running on a processor, a processor, an object, an executable, a thread of execution, a program, and/or a computer. By way of illustration and not limitation, both an application running on a server and the server itself can be a component. One or more components may reside within a process and/or thread of execution and a component may be localized on one computer and/or distributed between two or more computers. In addition, components may execute from various computer-readable media, device-readable storage devices, or machine-readable media having various data structures stored thereon. The components may communicate via local and/or remote processes such as in accordance with a signal having one or more data packets (e.g., data from one component interacting with another component in a local system, a distributed system, and/or across a network such as the Internet with other systems via the signal). As another example, a component can be an apparatus with specific functionality provided by mechanical parts operated by electric or electronic circuitry, which may be operated by a software or firmware application executed by a processor, wherein the processor can be internal or external to the apparatus and executes at least a part of the software or firmware application. As yet another example, a component can be an apparatus that provides specific functionality through electronic components without mechanical parts; the electronic components can include a processor therein to execute software or firmware that confers at least in part the functionality of the electronic components.

To the extent used in the subject specification, terms such as “store,” “storage,” “data store,” data storage,” “database,” and the like refer to memory components, entities embodied in a memory, or components comprising a memory. It will be appreciated that the memory components described herein can be either volatile memory or nonvolatile memory, or can include both volatile and nonvolatile memory.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A, X employs B, or X employs both A and B, then “X employs A or B” is satisfied under any of the foregoing instances. Moreover, articles “a” and “an” as used in the subject disclosure and claims should generally be construed to mean “one or more” unless specified otherwise or clear from context to be directed to a singular form.

The words “exemplary” and/or “demonstrative,” to the extent used herein, mean serving as an example, instance, or illustration. For the avoidance of doubt, the subject matter disclosed herein is not limited by disclosed examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive, in a manner similar to the term “comprising” as an open transition word, without precluding any additional or other elements.

As used herein, the term “infer” or “inference” refers generally to the process of reasoning about, or inferring states of, the system, environment, user, and/or intent from a set of observations as captured via events and/or data. Captured data and events can include user data, device data, environment data, data from sensors, application data, implicit data, explicit data, etc. Inference can be employed to identify a specific context or action or can generate a probability distribution over states of interest based on a consideration of data and events, for example.

The disclosed subject matter can be implemented as a method, apparatus, or article of manufacture using standard programming and/or engineering techniques to produce software, firmware, hardware, or any combination thereof to control a computer to implement the disclosed subject matter. The term “article of manufacture,” to the extent used herein, is intended to encompass a computer program accessible from any computer-readable device, machine-readable device, computer-readable carrier, computer-readable media, or machine-readable media. For example, computer-readable media can include, but are not limited to, a magnetic storage device, e.g., hard disk; floppy disk; magnetic strip(s); an optical disk (e.g., compact disk (CD), digital video disc (DVD), Blu-ray Disc™ (BD)); a smart card; a flash memory device (e.g., card, stick, key drive); a virtual device that emulates a storage device; and/or any combination of the above computer-readable media.

Generally, program modules include routines, programs, components, data structures, etc., that perform particular tasks or implement particular abstract data types. The illustrated embodiments of the subject disclosure may be practiced in distributed computing environments where certain tasks are performed by remote processing devices that are linked through a communications network. In a distributed computing environment, program modules can be located in both local and remote memory storage devices.

Computing devices can include at least computer-readable storage media, machine-readable storage media, and/or communications media. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media that can be used to store desired information. In this regard, the terms “tangible” or “non-transitory” herein as applied to storage, memory, or computer-readable media, are to be understood to exclude only propagating transitory signals per se as modifiers, and do not exclude any standard storage, memory or computer-readable media that are more than only propagating transitory signals per se.

Computer-readable storage media can be accessed by one or more local or remote computing devices, e.g., via access requests, queries, or other data retrieval protocols, for a variety of operations with respect to the information stored by the medium.

A system bus, as may be used herein, can be any of several types of bus structure that can further interconnect to a memory bus (with or without a memory controller), a peripheral bus, and a local bus using any of a variety of commercially available bus architectures. A database, as may be used herein, can include basic input/output system (BIOS) that can be stored in a non-volatile memory such as ROM, EPROM, or EEPROM, with BIOS containing the basic routines that help to transfer information between elements within a computer, such as during startup. RAM can also include a high-speed RAM such as static RAM for caching data. As used herein, a computer can operate in a networked environment using logical connections via wired and/or wireless communications to one or more remote computers. The remote computer(s) can be a workstation, server, router, personal computer, portable computer, microprocessor-based entertainment appliance, peer device, or other common network node. Logical connections depicted herein may include wired/wireless connectivity to a local area network (LAN) and/or larger networks, e.g., a wide area network (WAN). Such LAN and WAN networking environments are commonplace in offices and companies, and facilitate enterprise-wide computer networks, such as intranets, any of which can connect to a global communications network, e.g., the Internet. When used in a LAN networking environment, a computer can be connected to the LAN through a wired and/or wireless communication network interface or adapter. The adapter can facilitate wired or wireless communication to the LAN, which can also include a wireless access point (AP) disposed thereon for communicating with the adapter in a wireless mode.

When used in a WAN networking environment, a computer can include a modem or can be connected to a communications server on the WAN via other means for establishing communications over the WAN, such as by way of the Internet. The modem, which can be internal or external, and a wired or wireless device, can be connected to a system bus via an input device interface. In a networked environment, program modules depicted herein relative to a computer or portions thereof can be stored in a remote memory/storage device.

When used in either a LAN or WAN networking environment, a computer can access cloud storage systems or other network-based storage systems in addition to, or in place of, external storage devices. Generally, a connection between a computer and a cloud storage system can be established over a LAN or a WAN, e.g., via an adapter or a modem, respectively. Upon connecting a computer to an associated cloud storage system, an external storage interface can, with the aid of the adapter and/or modem, manage storage provided by the cloud storage system as it would other types of external storage. For instance, the external storage interface can be configured to provide access to cloud storage sources as if those sources were physically connected to the computer.

As employed in the subject specification, the term “processor” can refer to substantially any computing processing unit or device comprising, but not limited to comprising, single-core processors; single-core processors with software multithread execution capability; multi-core processors; multi-core processors with software multithread execution capability; multi-core processors with hardware multithread technology; vector processors; pipeline processors; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a state machine, discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. For example, a processor may be implemented as one or more processors together, tightly coupled, loosely coupled, or remotely located from each other. Multiple processing chips or multiple devices may share the performance of one or more functions described herein, and similarly, storage may be effected across a plurality of devices.

As an overview, various arrangements are described herein. For simplicity of explanation, the methods are depicted and described as a series of steps or actions. It is to be understood and appreciated that the various arrangements are not limited by the actions illustrated and/or by the order of actions. For example, actions can occur in various orders and/or concurrently, and with other actions not presented or described herein. Furthermore, not all illustrated actions may be required to implement the methods. In addition, the methods could alternatively be represented as a series of interrelated states via a state diagram or events. Additionally, the methods described hereafter are capable of being stored on an article of manufacture (e.g., a machine-readable storage medium) to facilitate transporting and transferring such methodologies to computers.

The system and method of the present teachings integrate device interrogation, device control, and trigger management to provide a complete system for device feature control. If the trigger is economic, this improvement can enable the user to have complete control over the budget for owning and operating a device, while the manufacturer/vendor can have complete control over the revenue from the device. In an exemplary configuration, the system can include a device component associated with the device itself, a management component performing the interface between the device and a trigger servicing means, for example, a commercially-available payment means. Other configurations can include, for example, but not limited to, a training tracking means, a user action tracking means, an action analysis means, an anomalous behavior tracking means, or a behavior tracking means. These means can be activated, individually or as a group, by, for example, the manufacturer/vendor, depending upon which types of feature control are desired. Alternatively, the management component or the device itself can initiate a protocol on a regular basis, or at pre-selected states, with the vendor to determine, for example, if lease payment has been received. In this way, control of the device cannot be taken over by a malicious actor posing as a vendor. The present teachings contemplate other types of monitor/trigger interfaces that can accommodate flexible control of the features of the device.

The device component can include instructions for interrogating the device for a features list. Smart devices can include on-board diagnostics and/or standard APIs, for example. On-board diagnostics can be used to discover devices in real-time and view events related to the devices. Information from vehicle on-board diagnostics that conform to standards such as OBD-II, ISO 9141, 11898, 14230, 15031, and 15765 can be easily accessed and utilized. Standard APIs can provide a generic means for the management component to send and receive commands and information to the device component. The device's manufacturer can provide specific ways to communicate with the device if a standard API isn't available. The device component includes at least the following interface options, whether they are achieved through standard APIs, custom APIs, or through accessing capabilities specific to the device: inventory feature list, inventory feature status, enable feature, and disable feature.

An exemplary trigger service, the commercial payment means, can be operated by a commercial vendor such as, for example, but not limited to, Amazon Pay, Stripe, Venmo for Business, GoCardless, Square Payments, Thryv, Snyder, or PayPal Here, a bank, the manufacturer, or a custom payment means. The payment means includes commercially-available financial security protections.

The management component initiates communication with both the commercial trigger service and at least one of the device components. Note that one management component can communicate with more than one device component simultaneously. The management component can communicate with the device component and the trigger service by any well-known electronic means involving a networking protocol, including, but not limited to, the internet, wi-fi, and Bluetooth. Configuring the interfaces among the components depends upon the type of communications used, and is well-known technology. When communications are configured, the management component determines which features the device has to offer. The management component continually updates this interrogation as features can become available or unavailable depending upon the status of the device. For example, a user might disable a feature for safety reasons. The management component maintains a current list of device features. The device component determines the status of the feature when requested by the management component, and provides the status to the management component. The management component maintains a database with the features and the status of the features.

The management component, using device identification information and feature identification information, requests, for example, when the trigger is economic, payment information from the trigger service. The management component compares the feature database with the payment information. When there is a discrepancy, the management component checks the status of the feature. If the discrepancy is that the feature is shown to be enabled by the device, but the feature did not meet at least one pre-selected criterion, the management component determines whether it would be safe to disable the feature. One way that the management component determines whether disabling the feature is safe is by accessing a database that provides a current feature state list and a proposed feature state list, the proposed feature state being a disabled state. Whether or not to disable the feature is based at least on the relationship between the current feature state and the proposed feature state. Other possibilities can be available such as postponing disabling the feature for a pre-selected amount of time or until another disabling/enabling event occurs. Another disabling/enabling event can include, for example, the relocation or reconfiguration of the device to a safe place. If it is determined that the feature can be safely disabled, the management component sends a message to the device component to disable the feature, followed by a request for a feature list and a feature status list. The management component then updates its database with the data received from the device component. The present teachings contemplate a variety of states, in addition to enabled and disabled, and events that could be activated or deactivated by the process described herein. Further, features can be related to other features so that if a trigger relates to a first feature, the relationship would indicate an impact on the second feature, for example, disabling the second feature.

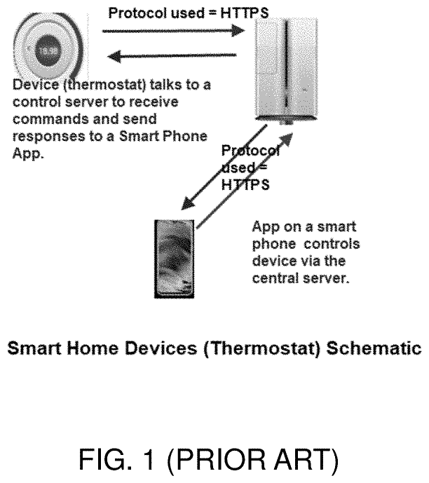

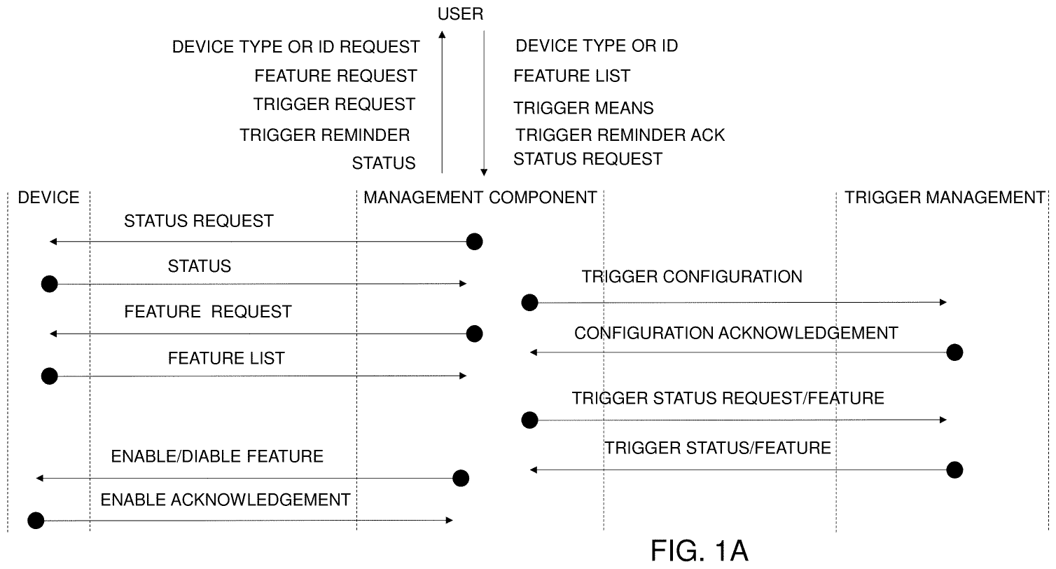

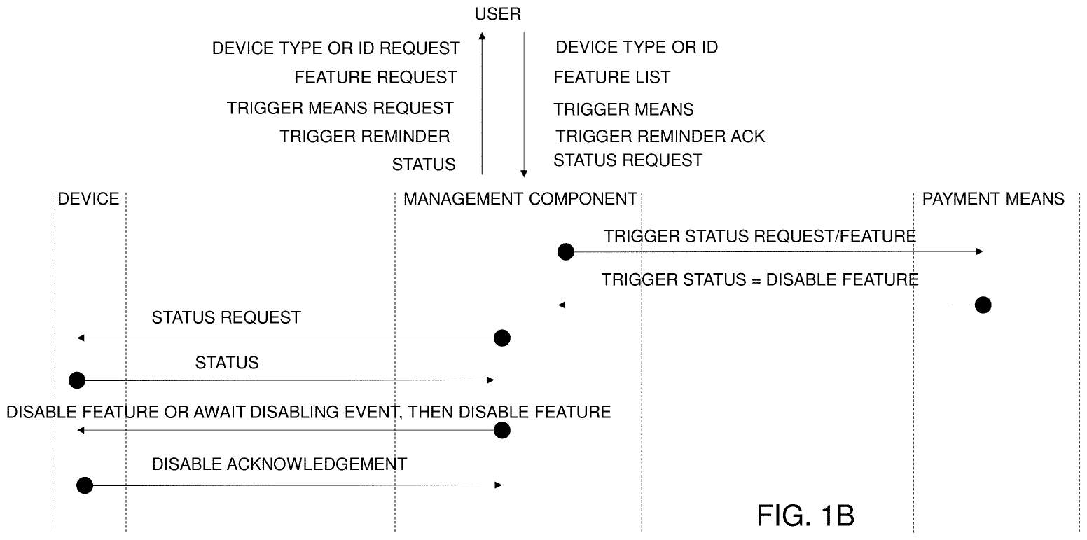

Referring now to FIGS. 1A-1B, possible messages that could be used to couple the management component with the device include messages that are initiated by the management component and messages that are initiated by the device in response to requests from the management component. Messages that are used to couple the management component with the trigger service, for example, a payment means, include messages that are initiated by the management component and messages that are initiated by the payment means in response to requests from the management component. Table I provides an exemplary list of messages.

TABLE I

| Management | Device → | Management | Payment means → |
|---|---|---|---|
| component → | Management | component → | Management |
| Device | component | Payment means | component |
| Device status | Status of device | Payment status | Payment/feature + |
| request | | request | payment date |
| Feature list request | Feature list | Payment means | Configuration |
| | | configuration | acknowledgement |
| Feature status | Feature status | | |
| request | | | |
| Enable feature | Enable | | |
| | acknowledgment | | |
| Disable feature | Disable | | |
| | acknowledgment | | |

In an aspect, configuration data can be gathered from a user, can be supplied by default values, and/or can be deduced from previous activity and/or environmental factors. If the information is gathered from a user, communications between the user and the management component can include, but are not limited to including, messages as shown in Table II.

TABLE II

| | |
|---|---|
| Management component → User | User → Management component |
| Device type or ID request | Device type or ID |
| Feature request | Feature list |
| Trigger service, e.g. payment means, | Trigger service, e.g. payment means |
| request | |
| Trigger, e.g. payment reminder | Trigger, e.g. payment reminder |
| | acknowledgement |
| Status | Status request |

Referring now to FIGs. 1A and 1B, exemplary communications among the components of the present teachings are shown. If the device is, for example, a thermostat, the user can enter an identification number associated with the thermostat when the management component device type or ID request is displayed. Alternatively, if the user provides a device type (versus a device ID), the system of the present teachings can search for devices of that type associated with the user, and can proceed with a feature template, or inquire whether the user wants to update the possible list of features. This option can be used if, for example, the device does not have a feature query capability, but has a well-known feature list, such as a thermostat. A default thermostat feature list can include, for example, the list in Table III.

Continuing to refer to FIGS. 1A-1B, the entry of an identification number can direct the exemplary system to locate a device with the proper identification associated with the user and send a status request to the device. The device returns a status to the management component as a response to a status request. The value of the status depends upon the type of device, for example, manufacturer's possible values, or a pre-selected set of values. If the returned status indicates that the device is available for communication with the management component, the management component requests a list of features that the device has to offer. While the management component is awaiting responses from the device, the management component can request from the user a trigger service, e.g. a payment means, and configure the trigger service, e.g. payment means. For example, if the user wants to pay by PayPal, the management component can establish that the user has a PayPal account and that the payment means is adequately funded. The management component can inform the user of any issues with the payment means. When the management component determines the features list, the payment means can be informed of the features that the user selects and can be charged for those features, the process for which is well-known. When the features are paid for, the management component can send a request to the device to enable the selected features and/or related features. The device enables the features and responds with an acknowledgement, and/or information about issues with enabling the features. If there are issues, the management component can inform the user and refund the money, for example, or give the user other options, as is known in the art. Periodically, the management component can request payment status for the leased features. For example, the management component can request status when it is known that a certain amount of time has elapsed, for example, each month or other billing cycle. This time period can be set by the user, and/or can be a default value, and/or can be determined by the activities of the user. If the expected payment has not been made, the management component can request a status of the device. When the device returns a status, the management component can determine, according to expected behavior or pre-selected states of the device, the mode or state the device is in. For example, a thermostat can be activating the heating system in a building. The management component determines, from information maintained or discovered about the device whether or not it is safe to disable a feature that has not been paid for. For example, if the temperature in the building, before the thermostat activates the heating system, approaches a threshold value in which harm could come to the contents of the building if the heating system is not activated, the management system can delay deactivation until a pre-selected, default, or dynamically-determined enabling/disabling event takes place. For example, the thermostat will activate the heating system before the feature becomes disabled.

Continuing to refer to FIGS. 1A-1B, disabling of features for an exemplary thermostat can begin with, for example, but not limited to, accessing a dataset such as in Table III.

TABLE III

| Feature | Disabling event | Disable by |
|---|---|---|
| Geo-fencing | Complete any outstanding | Turn off geo-fencing |
| | thermostat actions | |
| Proximity sensor | Proximity sensor data | Turn off proximity |
| | completely received and | sensor |
| | recorded | |
| Room sensor | Room sensor data completely | Turn off room sensor |
| | received and recorded | |
| Energy tracking + | Report completely provided | Turn off energy |
| reports | | tracking/reports |
| Climate zoning | Complete any outstanding | Turn off climate |
| | thermostat actions | zoning |
| Remote sensors | Remote sensor data completely | Turn off remote |
| | received and recorded | sensors |
| Habit adaptation | Complete any database update | Turn off habit |
| | | adaptation |

Continuing to refer to FIG. 1A-1B, the dataset can include a default list of features associated with a type of device, or can be provided by the device itself. Alternatively, the list of features can be formed over time as the user attempts to access features. Handshaking between the management component can then include prompting the user to pay for the feature, or charging the account associated with the user automatically for using the feature through the payment means. Information associated with the feature, as exemplarily provided in Table III (and Tables IV and V) can be updated by the management component, for example, when the management component receives an update from the user, or when the management component detects that an event of interest can no longer occur, possibly because of a configuration change, or if the device is malfunctioning.

Continuing to refer to FIGS. 1A-1B, in another example, the device can be a smart television. Table IV shows an exemplary beginning of a disable configuration for a smart television with the listed features. Note that features can be added or deleted at any time based on the status requests and feature lists set out in FIGS. 1A and 1B, or user choice.

TABLE IV

| Feature | Disabling event | Disable by |
|---|---|---|
| Remote control | Complete any outstanding | Turn off remote signal |
| | commands | |
| Captions | Complete any outstanding | Turn off captions |
| | captions | |
| Streaming video | Complete any outstanding | Turn off streaming |
| | video frames | video |
| Streaming music | Complete any outstanding | Turn off streaming music |
| | transmissions | |
| Media player | Complete any outstanding | Turn off media player |
| | media frames | |
| Search engine | Complete any outstanding | Disable search engine |
| | searches | prompt |
| Games | Complete any outstanding | Disable access to games |
| | gaming commands | |
| Content transfer | Complete transfer | Disable content transfer |
| | | access |
| App store | Complete any outstanding | Disable app store access |
| | purchases | |
| Remote meeting | Complete a pre-selected | Disable remote meeting |
| | amount of meeting time | access |
| Voice control | Complete any outstanding | Disable voice control |
| | voice commands | |
| Motion control | Complete any outstanding | Disable motion control |
| | motion commands | |

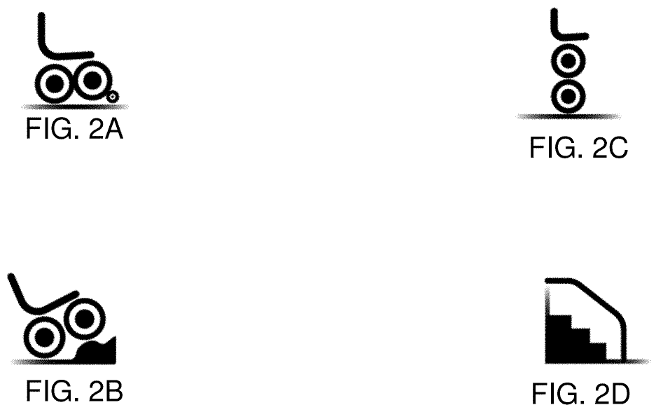

Referring now to FIGs. 2A-2D, in yet another example, the device can be a smart wheelchair having various configurations and autonomous features. For example, the configurations can include, but aren't limited to including, standard mode (FIG. 2A), curb traversal mode (FIG. 2B), balance mode (FIG. 2C), and stair mode (FIG. 2D). Other modes are contemplated by the system of the present teachings. The smart wheelchair can accommodate a feature query by the management component directly or through a device add-on that can communicate with the device to examine available features and otherwise provide the interface between the management component and the device. A wheelchair is an example, of a medical device. Remote control of a medical device can present security risks. The system of the present teachings can enforce a feature protocol that, for example, is initiated periodically by the medical device. Such an initiation can protect the medical device (or any device) from imposter control. The protocol can include, in addition to the medical device's initiating communication with the management component, the management component's communicating with the trigger service and receiving assurance that the communications between the management component and the trigger service are secure. In another aspect, the communication between the management component and the device can be continuously monitored for security breathes, and the management component can periodically initiate communications with the trigger service. In another aspect, communications with the trigger service can be limited to occurring with the medical device is physically connected to a secure port. For example, if the medical device is a wheelchair, communications with the trigger service can be limited to when the wheelchair is docked. In general, when the controlled device is a medical device, the slave/master relationship between the trigger service and the management component, and/or the trigger service and the device, places the device in the master position and the trigger service as slave, even though the trigger service is still capable of disabling features/related features of the device. The device asks for instructions from the trigger service. Table V shows an exemplary configuration that the wheelchair could find itself in before the listed feature could be disabled. Again, the features list is exemplary only, and can be updated at any time.

TABLE V

| Feature | Disabling event | Disable by |
|---|---|---|
| Remote | Complete any outstanding | Turn off remote |
| control | commands | signal |
| Autonomous | Complete navigating to/from | Disable docking |
| docking | dock | mode |
| Autonomous | Safe stopping point, safe | Disable autonomous |
| driving | configuration, standard mode | features - possibly |
| | | feature-by-feature |
| Stair climbing | Safe stopping point, safe | Disable stair |
| | configuration, standard mode | climbing features |
| Balance mode | Safe stopping point, safe | Disable balance |
| | configuration, standard mode | mode features |
| Curb traversal | Safe stopping point, safe | Disable curb |
| | configuration, standard mode | traversal features |
| Autonomous | Safe stopping point, safe | Disable autonomous |
| speed control | configuration, standard mode | speed control |
| | | features |
| Mode select | Safe stopping point, safe | Disable mode select |
| | configuration, standard mode | features |

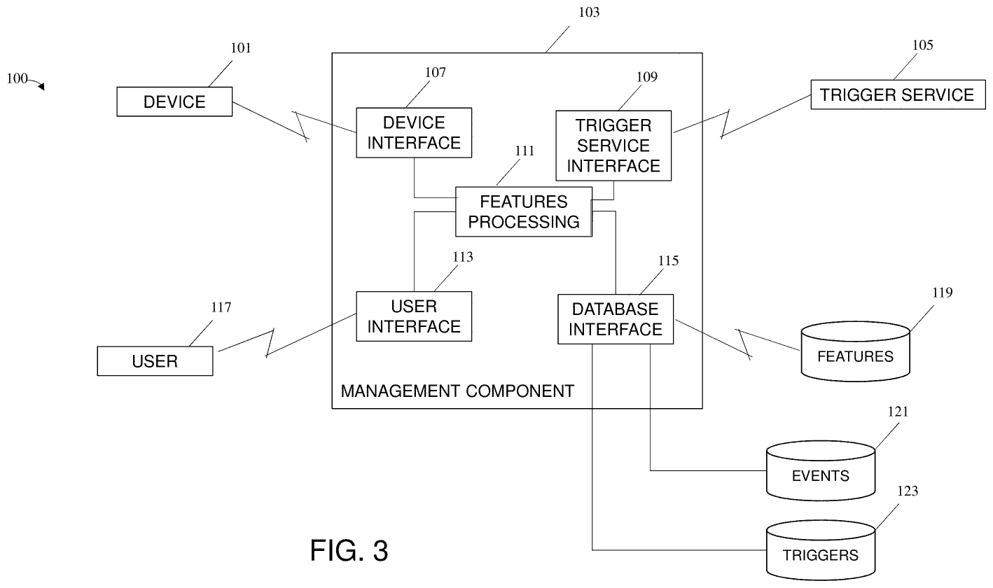

Referring now to FIG. 3, an exemplary implementation of the system of the present teachings is shown. In the pictured configuration, system 100 can include management component 103, executing on a general purpose processor or a special purpose processor, including user interface module 117, executing on the same processor as management component, or on one or more separate processors. With respect to all the processors introduced herein, instruction execution can occur in parallel or sequentially, based on available hardware. Instructions to implement the functions of the present teachings can be executing in software, firmware, or on a processor mounted upon a circuit board that has been specifically designed for the purpose of executing instructions to enable the present teachings. Further, management component 103 can execute in the “cloud”, i.e. remotely from trigger service 105, device 101, user 117, and the database. Management component 103 can also execute locally with some or all of its interfaces. For example, management component 103 can interface with a local features database 119, and remote events database 121 and triggers database 123. Any such configuration is possible under the present teachings. Still further, all components of the system can be located locally with respect to each other, but can communicate through wireless means or wired means, the wireless means enabling the components to move with respect to each other without losing continuity of the goals of the present teachings.

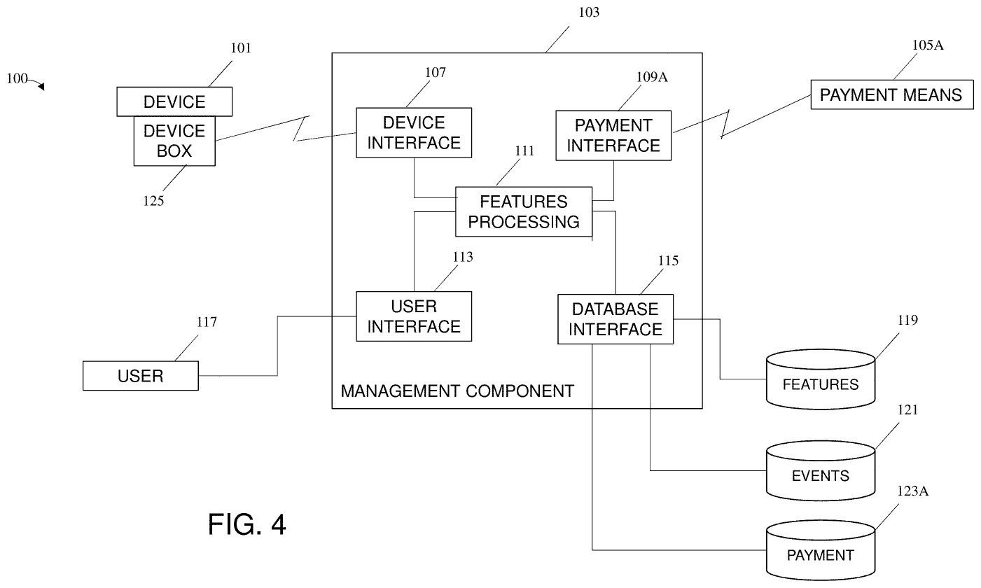

Continuing to refer to FIG. 3, user interface 117 can include instructions to prompt user 117 for information such as the device for which the user is planning to lease, rent, or purchase various features to enhance the usability of the device. With an identification of the device, or alternatively with a device type, user interface 113 can execute instructions to initiate the process of determining possible features associated with device 101. Further, user interface 113 can execute instructions to prompt the user for payment information. Using the payment information, trigger service 105 (such as payment means 105A (FIG. 4)) can be configured and associated with user 117.

Continuing to refer to FIG. 3, in the exemplary configuration, all inputs travel through features processing 111 which executes instructions to coordinate the activities of user interface 113, device interface 107, trigger service interface 109 (such as payment interface 109A (FIG. 4)), and database interface 115. Other configurations are contemplated by the present teachings. For example, user interface 113 can execute instructions to communicate directly with trigger service interface 109 when an account setup is being accomplished. In this example, user information such as a credit card or other payment means account number(s) are needed, but no information about features is needed at this point. Other alternative configurations are contemplated and would be possible to implement by one skilled in the art.

Continuing to still further refer to FIG. 3, features processing 111 can use the information gathered from the user or elsewhere to drive both device interface 107 and trigger service interface 109. For example, features processing 111 can determine, from the user's input, whether a features template is desired, or if features 119 are expected to be determined from interrogating the device itself. Regardless of the input from user interface 113, features processing 111 can proceed with executing instructions to initiate feature interrogation through device interface 107. If device interrogation fails, the default device type template can be used to determine which features might be available to the user. If the template is chosen and, subsequently or in parallel, device interface 107 receives a features list from device 101 as a result of sending an interrogation request to device 101, device interface 107 can provide the data received from device 101 to features processing 111, and features processing 111 can execute instructions to direct database interface 115 to update features 119, as well as the template, with the actual available features.

Continuing to refer to FIG. 3, device interface 107 can determine, from device information provided by user 117, or determined by features processing 111, the type of interface required to communicate with device 101. For example, if device interface 107 has access to a message protocol or API associated with device 101, device interface 107 invokes that protocol to communicate with device 101. Device interface 107 can be deployed with a set of protocols that are associated with commonly-used devices, or can be outfitted with specific protocols of devices that management component 103 is expected to be used for. In some configurations, user 117 can provide a list of devices that are expected to be managed, and management component 103 can execute instructions that either invoke various instances of device interface 107, one for each device in the list, or device interface 107 is configured to manage several devices at once. In any case, device interface(s) 107 receives a list of features for each device with which it is in communication and provides those lists to features processing 111.

Continuing to still further refer to FIG. 3, features processing 111 executes instructions to invoke trigger service interface 109, providing trigger service interface 109 with information about how each of the features in each of the devices is to be serviced. User 117 could have provided some of this information, or device 101 could have the feature/payment method information on board. In some configurations, trigger service interface 109 executes instructions to check the viability of the payment information with the designated trigger service 105. In some configurations, there is more than one of trigger service 105, allowing user 117 to pick one of trigger services 105 for certain features, another of trigger services 105 for other features. In some configurations, payment means 105A (FIG. 4) can include commercially available ways to make a purchase like PayPal, or can include customized ways to pay, or a combination. When the payment information has been validated or not, payment interface 109A (FIG. 4) executes instructions to communicate the status of the payment information to features processing 111. In the case where the payment information validates, features processing 111 can associate features 119 with payment 123A (FIG. 4), thus enabling pay by feature. When the payment information does not validate, it will not be possible for user 117 to take advantage of the feature associated with the non-validated payment information until the problems with the payment information are corrected.

Continuing to yet still further refer to FIG. 3, before features that are successfully associated with payment information can be enabled, safe disabling of features 119 must be established. For example, if device 101 is a wheelchair, and one of the features of the wheelchair is that the wheelchair can enter balance mode as shown in FIG. 2C, to safely disable the balance mode feature, the wheelchair would have to be brought to the ground, for example standard mode as shown in FIG. 2A, before the balance mode feature could be disabled. There are many examples in most smart devices of situations in which shutting down a feature could be unsafe for people, animals, or property, or in which the misuse of features can indicate safety issues and might require disabling related features. Related features can be set by a user or can be determined automatically based on normal use of the device. A safe configuration for the device for each feature can be established either by user 117, or by default, or dynamically determined, or a combination of ways. Examples of safe landings for various features are shown in Tables III-V. Other possibilities are contemplated by the present teachings.

Continuing to refer to FIG. 3, features processing 111 can execute instructions to device interface 107 to direct device 101 to enable features 119 that have been paid for. In some configurations, timers are associated with each feature with respect to payment, and status requests of both device 101 and payment means 105 are transmitted periodically. The feature will continue to be enabled as long as regular payments are made and/or other, if any, contractual obligations are met. For example, regular maintenance on the device feature could be required, and if that is neglected, it is possible that the device feature may be disabled. In another example, if the user has failed to take required training on a feature of the device, the feature or the entire device can be disabled. Further, if use of the feature and/or the device over time indicates that the user is irresponsibly interacting with the feature and/or the device, the feature/device can be disabled. Log files can be maintained and analyzed to determine misuse or anomalous behavior over time. Still further, features can be related to each other such that when one feature is shown to be misused, the related feature(s) and the misused feature can be disabled. In another aspect, the device can be deployed fully equipped, but only certain of its features can be enabled until events of interest occur. For example, wheelchair batteries can be deployed but disabled until additional range is necessary and the user fulfills contractual obligations to obtain the additional range. The additional features can be provided for a specific time period, such as a single use situation, or can be continuously provided. In an aspect, if an event of interest occurs that is not related to a user action or inaction, the system of the present teachings can, sua sponte, disable features based on the event of interest, or combination of events.

Continuing to refer to FIG. 3, a disable sequence can be implemented in at least four parts. The first part determines that some aspect of a contractual obligation has been breached, the second part determines the current state of the device, the third part determines a safe landing for the device in the current state with respect to the feature, and the fourth part disables the feature and/or related feature(s). User notification and feedback can be, but is not required to be, executed at any time in the disable sequence. Features processing 111 manages, in conjunction with trigger service interface 109 and possibly other contract-tracking means interface, determines that the feature is in jeopardy of being disabled because some aspect of the contract has been neglected. Features processing 111 can, for example, execute instructions to prompt the user for, for example, payment before disabling the feature. There can be multiple prompts over the course of a pre-selected amount of time before finally disabling the feature, or there can be no reminders. When it is determined that the feature will in fact be disabled, device interface 107 executes instructions to check the status of device 101. Within this status is the current state of the device 101. If the current state of the device allows the feature to be disabled safely, no safe landing reconfiguration is necessary, and device interface 107 can execute instructions to disable the feature in question. If, at any time during the prompt sequence, a payment is made towards maintaining the feature in an enabled state, features processing 111 executes instructions to re-enable the feature. Any possible safety issues associated with an abrupt re-enabling of the feature can be addressed before activating the feature.

Referring now to FIG. 4, another exemplary configuration is illustrated in which the trigger is payment/non-payment for the feature. In this configuration, a physical device can be fitted with device box 125. Device box 125 includes a connector and protocols compatible with the device such as, for example, but not limited to, a D-sub, MDR, USB, IEEE1394, RJ, and CENTRONICS, V35, or optical connectors. Some of the functions performed by device interface 107 can be offloaded into device box 125. In addition, device box 125 can be constructed specifically for a device type so that feature and status queries can be optimized.

Continuing to refer to FIG. 4, types of devices that could be configured with device box 125 can include, but are not limited to including, vehicles such as cars, wheelchairs, farm equipment, washing machines/dryers, and motorcycles. The functionality described herein can be built into device box 125 that a leasing company adds to the vehicle or device. In a vehicle, device box 125 can be a third-party option, and can be connected to the ignition of the vehicle, for example. Such a connection can prohibit the vehicle from restarting, but only when the vehicle has arrived at a safe place. Device box 125 can include its own GPS, or can use the vehicle's GPS, to determine the vehicle's location, and whether or not the location is safe, for example, at the user's home. Device box 125 can communicate with device interface 107, which can initiate enabling or disabling of the vehicle based on information gathered by payment interface 109A. Meanwhile, user interface 113 can remind the vehicle's user, and possibly others, through text messages and emails, for example, to pay past due payments. User interface 113 can also warn the user of reduced or removed device functionality in the near future. For a device such as a smart phone, the data connection could be disconnected if the user is delinquent in paying for the phone itself.

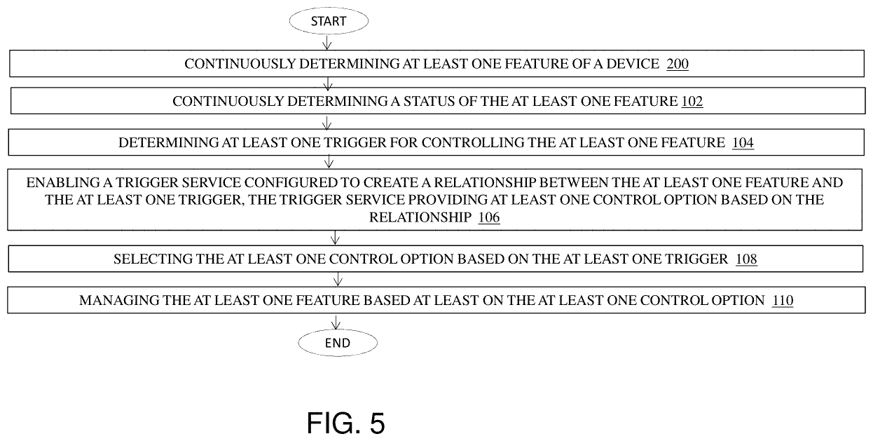

Referring now to FIG. 5, the method of the present teachings can include, but is not limited to including, continuously determining 200 at least one of the features of the device, continuously determining 102 a status of the at least one feature, determining 104 at least one trigger for controlling the at least one feature, enabling 106 a trigger service configured to create a relationship between the at least one feature and the at least one trigger, the trigger service providing at least one control option based on the relationship, selecting 108 the at least one control option based on the at least one trigger, and managing 110 the at least one feature based at least on the at least one control option. The features can be determined by interrogating the device, or by interrogating the user for a feature list or for device identification. The device identification can be used to determine a means for communicating with the device, or for determining a list of features the device advertises. The user can also provide a device type which can be associated with a default list of features. The device type can be determined automatically by interrogating the device, where possible. The status of the features can be determined by requesting the status from the device. In some configurations, a manufacturer provides a way to communicate with the device. In some configurations, the device can be fitted with an interrogation tool that can be developed for the specific device or for a specific device type. In some configurations, triggers can be specified to the system of the present teachings by the manufacturer/vendor. For example, the manufacturer/vendor can specify a trigger to be non-payment of a rental/lease fee for the feature. In another example, the manufacturer/vendor can specify a trigger to be attendance at a training class for the feature, or the irresponsible or uninformed use of the feature. When the feature/device experiences an event, and the event is a trigger, the previously-established or dynamically determined relationship between the trigger and the feature is accessed, and at least one control option that is associated with the relationship is accessed. The control option can indicate to the system that the feature needs to be controlled based on the trigger. Simple control options include enabling or disabling the feature. Other control options include partially disabling/enabling the feature, partially or completely disabling/enabling multiple dependent features that depend upon the primary feature, permanently disabling/enabling the feature, taking subsequent actions based upon features related to the feature in question, and temporarily disabling/enabling the feature. Several control options can be related to a particular trigger/feature pair, and several trigger/feature pairs can be related to a particular control option. When several control options are related to a particular trigger/feature, one of the control options can be selected based on criteria such as the safety of the device if the option were executed.

In an aspect, the method of the present teachings can optionally include correlating at least one mode of the device with the at least one feature, and changing a current of the at least one mode to future of the at least one mode based at least on the at least one control option.

In an aspect, the method of the present teachings can optionally include disabling execution of the at least one control option when a pre-selected condition would occur if the at least one control option were executed.

In an aspect, the method of the present teachings can optionally include wherein the pre-selected condition comprises an unsafe condition.

In an aspect, the method of the present teachings can optionally include wherein the at least one control option comprises disabling the at least one feature.

In an aspect, the method of the present teachings can optionally include wherein the at least one control option comprises enabling the at least one feature.

In an aspect, the method of the present teachings can optionally include wherein the status comprises available.

In an aspect, the method of the present teachings can optionally include wherein the status comprises active.

In an aspect, the method of the present teachings can optionally include wherein the at least one trigger comprises non-payment for the at least one feature.

In an aspect, the method of the present teachings can optionally include wherein the at least one trigger comprises payment for the at least one feature.

In an aspect, the method of the present teachings can optionally include wherein the device comprises a wheelchair.

In an aspect, the method of the present teachings can optionally include wherein the at least one feature comprises stair-climbing.

Those of skill in the art would understand that information and signals may be represented using any of a variety of different existing techniques. For example, data, instructions, commands, information, signals, bits, symbols, or chips that may be referenced throughout the description may be represented by voltages, currents, electromagnetic waves, magnetic fields or particles, optical fields or particles, ultrasonic waves, projected capacitance, or any combination thereof.

Those of skill would further appreciate that the various illustrative logical blocks, modules, circuits, and method steps described in connection with the arrangements disclosed herein may be implemented as electronic hardware, computer software, or combinations of both. To clearly illustrate this interchangeability of hardware and software, various illustrative components, blocks, modules, circuits, and steps have been described in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the appended claims.

The various illustrative logical blocks, modules, and circuits described in connection with the arrangements disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The actions of a method described in connection with the arrangements disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor. The processor and the storage medium may reside in an ASIC. The ASIC may reside in functional equipment such as, e.g., a computer, a robot, a user terminal, a mobile telephone or tablet, a car, or an IP camera. In the alternative, the processor and the storage medium may reside as discrete components in such functional equipment.

The above description is not intended to be exhaustive or to limit the features to the precise forms disclosed. Various alternatives and modifications can be devised by those skilled in the art without departing from the disclosure, and the generic principles defined herein may be applied to other aspects without departing from the spirit or scope of the appended claims. Accordingly, the present disclosure is intended to embrace all such alternatives, modifications and variances. Additionally, while several arrangements of the present disclosure have been shown in the drawings and/or discussed herein, it is not intended that the disclosure be limited thereto, as it is intended that the disclosure be as broad in scope as the art will allow and that the specification be read likewise. Therefore, the above description should not be construed as limiting, but merely as examples of particular configurations. And those skilled in the art will envision other modifications within the scope and spirit of the claims appended hereto. Other elements, steps, actions, methods, and techniques that are not substantially different from those described above and/or in the appended claims are also intended to be within the scope of the disclosure. Thus, the appended claims are not intended to be limited to the arrangements shown and described herein, but are to be accorded the broadest scope consistent with the principles and novel features disclosed herein.

The arrangements shown in drawings are presented only to demonstrate certain examples of the disclosure. And, the drawings described are merely illustrative and are non-limiting. In the drawings, for illustrative purposes, the size of some of the elements may be exaggerated and not drawn to a particular scale. Additionally, elements shown within the drawings that have the same numbers may be identical elements or may be similar elements, depending on the context.

Where the term “comprising” is used in the present description and claims, it does not exclude other elements or steps. Where an indefinite or definite article is used when referring to a singular noun, e.g. “a” “an” or “the”, this includes a plural of that noun unless something otherwise is specifically stated. Hence, the term “comprising” should not be interpreted as being restricted to the items listed thereafter; it does not exclude other elements or steps, and so the scope of the expression “a device comprising items A and B” should not be limited to devices consisting only of components A and B. Furthermore, to the extent that the terms “includes,” “has,” “possesses,” and the like are used in the present description and claims, such terms are intended to be inclusive in a manner similar to the term “comprising,” as “comprising” is interpreted when employed as a transitional word in a claim.

Furthermore, the terms “first”, “second”, “third” and the like, whether used in the description or in the claims, are provided to distinguish between similar elements and not necessarily to describe a sequential or chronological order. It is to be understood that the terms so used are interchangeable under appropriate circumstances (unless clearly disclosed otherwise) and that the aspects of the disclosure described herein are capable of operation in other sequences and/or arrangements than are described or illustrated herein.

What is claimed is:

1. A method for managing at least one feature in a device under contract by a user, the method comprising:
continuously determining the at least one feature of the device;
continuously determining a status of the at least one feature;
determining at least one trigger for controlling the at least one feature;
enabling a trigger service configured to create a relationship between the at least one feature and the at least one trigger, the trigger service providing at least one control option based on the relationship;
selecting the at least one control option based on the at least one trigger; and
managing the at least one feature based at least on the at least one control option.

2. The method as in claim 1 further comprising:
correlating at least one mode of the device with the at least one feature; and
changing a current of the at least one mode to future of the at least one mode based at least on the at least one control option.

3. The method as in claim 1 further comprising:
disabling execution of the at least one control option when a pre-selected condition would occur if the at least one control option were executed.

4. The method as in claim 3 wherein the pre-selected condition comprises an unsafe condition.

5. The method as in claim 1 wherein the at least one control option comprises disabling the at least one feature.

6. The method as in claim 1 wherein the at least one control option comprises enabling the at least one feature.

7. The method as in claim 1 wherein the status comprises available.

8. The method as in claim 1 wherein the status comprises active.

9. The method as in claim 1 wherein the at least one trigger comprises non-payment for the at least one feature.

10. The method as in claim 1 wherein the at least one trigger comprises payment for the at least one feature.

11. The method as in claim 1 wherein the device comprises a wheelchair.

12. The method as in claim 11 further comprising:
adjusting a speed of the wheelchair based at least on the at least one trigger.

13. The method as in claim 11 wherein the at least one feature comprises stair-climbing.

14. The method as in claim 1 further comprising:
correlating a first at least one feature with a second at least one feature; and
modifying the first at least one feature based on changes to the second at least one feature.

15. A feature management system comprising:
a processor configured to execute instructions including:
continuously determining at least one feature of a device;
continuously determining a status of the at least one feature;
determining at least one trigger for controlling the at least one feature;
enabling a trigger service configured to create a relationship between the at least one feature and the at least one trigger, the trigger service providing at least one control option based on the relationship;
selecting the at least one control option based on the at least one trigger; and
managing the at least one feature based at least on the at least one control option.

16. The feature management system as in claim 15 wherein the trigger service comprises:
a payment service.

17. The feature management system as in claim 15 wherein the instructions further comprise:
correlating at least one mode of the device with the at least one feature; and
changing a current of the at least one mode to future of the at least one mode based at least on the at least one control option.

18. The feature management system as in claim 15 wherein the instructions further comprise:
disabling execution of the at least one control option when a pre-selected condition would occur if the at least one control option were executed.

19. The feature management system as in claim 18 wherein the pre-selected condition comprises an unsafe condition.

20. The feature management system as in claim 15 wherein the at least one control option comprises disabling the at least one feature.

21. The feature management system as in claim 15 wherein the at least one control option comprises enabling the at least one feature.

22. The feature management system as in claim 15 wherein the at least one trigger comprises non-payment for the at least one feature.

23. The feature management system as in claim 15 wherein the at least one trigger comprises payment for the at least one feature.

24. The feature management system as in claim 15 wherein the device comprises a wheelchair.

25. The feature management system as in claim 24 wherein the at least one feature comprises stair-climbing.
